(19) United States
(12) Patent Application Publication
(10) Pub. No.: US 2009/0161579 A1
(43) Pub. Date: Jun. 25, 2009

(54) Method, system, and apparatus for implementing network capable input devices

(76) Inventors: Mika Saaranen, Pirkkala (FI); Antti Tapiola, Kisko (FI)

Correspondence Address: Hollingsworth & Funk, LLC, 8009 34th Avenue South, Suite 125, Minneapolis, MN, 54425, US

(21) Appl. No.: 12/004,198

(22) Filed: Dec. 20, 2007

(51) Int. Cl. H04L 12/28

(52) U.S. Cl. 370/254

(57) ABSTRACT

Interaction with network capable input device involves advertising, from a mobile device coupled to an Internet Protocol (IP) network, a user input service via an ad-hoc peer-to-peer protocol of the IP network. The user input service is established with a controlled device via the ad-hoc, peer-to-peer protocol. User input events are detected at the mobile device, and the user input events are provided to the controlled device in accordance with parameters of the established user input service.

### FIELD OF THE INVENTION

This invention relates to input device interactions via ad-hoc, peer-to-networks.

### BACKGROUND OF THE INVENTION

UPnP™ technology defines architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. UPnP technology provides a distributed, open networking architecture that leverages TCP/IP and the Web technologies to enable seamless proximity networking in addition to control and data transfer among networked devices.

The UPnP Device Architecture (UDA) is designed to support zero-configuration, “invisible” networking, and automatic discovery for a breadth of device categories from a wide range of vendors. This means a device can dynamically join a network, obtain an IP address, convey its capabilities, and learn about the presence and capabilities of other devices.

Mobile device vendors are adding sensors to devices that enable detecting position, acceleration, angle, etc. of the device. These sensors allow many applications to use features such as keeping the display image at the correct viewing orientation even if the device itself is be turned to various positions. These sensors may also allow recognition of gestures. Therefore, new ways of taking advantage of these types of sensors on local networks are desirable. Similarly, the chipsets that allows mobile devices to connect to wireless local area networks (WLAN) are becoming commoditized. As such, other sensing and/or input devices may also be able to inexpensively include network features similar to mobile devices.

### SUMMARY OF THE INVENTION

To overcome limitations in the prior art described above, and to overcome other limitations that will become apparent upon reading and understanding the present specification, the present invention discloses a system, apparatus and method for user interactions via a network capable input device. In accordance with one embodiment of the invention, an apparatus includes a user input device and at least one network interface capable of being coupled to an Internet Protocol (IP) network. A processor is coupled to the network interface and the user input device. Memory is coupled to the processor and includes instructions that cause the processor to advertise a user input service via an ad-hoc, peer-to-peer protocol of the IP network. The apparatus establishes the user input service with a controlled device via the ad-hoc, peer-to-peer protocol and detects user input events from the user input device. The apparatus provides the user input events to the controlled device in accordance with parameters of the established user input service.

In a more particular embodiment of the apparatus, the instructions cause the processor to provide the user input events to the controlled device via the IP network. In such a case, the instructions may cause the processor to provide the user input events to the controlled device via the ad-hoc, peer-to-peer protocol of the IP network. Alternatively, the instructions cause the processor to provide the user input events to the controlled device via a direct wireless ad-hoc connection coupling the mobile apparatus to the controlled device. In other more particular embodiments, the user input device includes a motion sensor, and the user input events include motion events. In another configuration, the user input device includes key switches, and the user input events comprise key press events.

In another more particular embodiment, the instructions further cause the processor to: 1) discover a user output service of the controlled device via the ad-hoc, peer-to-peer protocol; 2) establish the user output service with the controlled device via the ad-hoc, peer-to-peer protocol; 3) receive user output events from the user output service; and 4) translate the user output events to user-perceivable signals via the user output device, wherein the user output signals are related to an activity being engaged in by the user on the controlled device using the user input signals.

In more particular embodiments of the apparatus, the user input service includes a text messaging service, and the controlled device includes a text messaging receiving device capable of enabling rendering text data to the user from the text messaging service. In such a case, the text data may include a destination entry describing a target application of the text messaging receiving device for processing the text data. In another variation, the controlled device may include a plurality of text messaging devices capable of simultaneously receiving the text data.

In a another embodiment of the invention, a method involves advertising, from a mobile device coupled to an Internet Protocol (IP) network, a user input service via an ad-hoc peer-to-peer protocol of the IP network. The user input service is established with a controlled device via the ad-hoc, peer-to-peer protocol, and user input events are detected at the mobile device. The user input events are provided to the controlled device in accordance with parameters of the established user input service.

In more particular embodiments of the method, providing the user input events to the controlled device may involve providing the user input events to the controlled device via the IP network. In such a case, providing the user input events to the controlled device via the IP network may involve providing the user input events to the controlled device via the ad-hoc, peer-to-peer protocol of the IP network. In another variation, providing the user input events to the controlled device comprises providing the user input events to the controlled device via a direct wireless ad-hoc connection coupling the mobile apparatus to the controlled device. In one configuration, wherein the user input device includes a motion sensor, and the user input events include motion events. In another configuration, the user input service includes a text messaging service, and the controlled device includes a text messaging receiving device capable of enabling rendering text data to the user from the text messaging service.

In another more particular embodiment, the method further involves discovering a user output service of the controlled device via the ad-hoc, peer-to-peer protocol. The user output service is established with the controlled device via the ad-hoc, peer-to-peer protocol. User output events are received from the user output service, and the method further involves translating the user output events to user-perceivable signals via the user output device,. The user output signals are related to an activity being engaged in by the user on the controlled device using the user input signals.

According to another embodiment of the invention, an apparatus includes at least one network interface capable of being coupled to an Internet Protocol (IP) network. A processor is coupled to the network interface, and memory is coupled to the processor. The memory includes a user application and instructions that causes the processor to: 1) discover a user input service via an ad-hoc, peer-to-peer protocol of the IP network; 2) establish the user input service via the ad-hoc, peer-to-peer protocol for providing user inputs to the user application; 3) receive user input events from the user input service in accordance with parameters of the established user input service; and 4) provide the user input events to the user application.

In a more particular embodiment, the instructions further cause the processor to: 1) advertise a user output service of the apparatus via the ad-hoc, peer-to-peer protocol; 2) establish the user output service with an input device that provides the user input service via the ad-hoc, peer-to-peer protocol; and 3) send user output events to the user input device, wherein the user input device translates the user output events to user-perceivable signals, wherein the user output signals are related to an activity being engaged in by the user on the controlled device using the user input signals.

In another embodiment of the invention, a system includes a mobile apparatus and controlled device capable of being coupled to an Internet protocol (IP) network that utilizes an ad-hoc peer-to-peer protocol. The mobile apparatus includes: 1) means for advertising a user input service via the ad-hoc, peer-to-peer protocol of the IP network; 2) means for establishing the user input service with a controlled device via the ad-hoc, peer-to-peer protocol; 3) means for detecting user input events at the mobile apparatus; and 4) means for providing the user input events to the controlled device in accordance with parameters of the established user input service. The controlled device includes: 1) a user application; 2) means for discovering the user input service via the ad-hoc, peer-to-peer protocol of the IP network; 3) means for establishing the user input service via the ad-hoc, peer-to-peer protocol for providing user inputs to the user application; 4) means for receiving user input events from the user input service in accordance with parameters of the established user input service; and 5) means for providing the user input events to the user application.

These and various other advantages and features of novelty are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWING

The invention is described in connection with the embodiments illustrated in the following diagrams.

FIG. 1 is a block diagram illustrating a system according to embodiments of the invention;

FIG. 2 is a block diagram showing functional components for logical devices according to various embodiments of the invention;

FIG. 3 is a block diagram showing additional interactions between functional components in a system according to embodiments of the invention;

FIG. 4 is a block diagram illustrating a mobile device according to embodiments of the invention;

FIGS. 5 is a block diagram illustrating a controlled device according to embodiments of the invention;

FIG. 6 is a flowchart showing a procedure according to embodiments of the invention;

FIG. 7 is a block diagram showing a text application implementation according to an embodiment of the invention; and

FIG. 8 is a flowchart showing a procedure according to embodiments of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Mobile devices are becoming smaller in size and at the same time becoming more powerful and including more extensive features. Further, there is ever increasing need for more convenient input devices for both mobile and fixed devices. Techniques defined in Digital Living Network Alliance (DLNA) and Universal Plug and Play (UPnP) forum allow using external renderers and allowing convenient consumption of media. However, what is missing from these standards are convenient input devices for uses such as convenient entering of metadata. For instance, editing song names or creating playlists are more convenient with a mouse and keyboard than with a small numeric keypad or infrared remote control.

Home networking technologies such as UPnP enable a wide variety of disparate devices to interact in ways that the manufacturers of those devices may not have foreseen or intended. For example, a typical home entertainment center (e.g., audio system, television) may be remotely controllable via a proprietary wireless (e.g., infrared or radio) controller. Typically, such controllers are shipped with the unit and tailored for the specific capabilities of the component. As new devices are added to the system, such as a DVD player or digital video recorder (DVR), a new remote is added to the user's tabletop. Eventually, the user's tabletop becomes cluttered with remote controls, and operation of the system may involve juggling a number of these remote controls in series.

In order to alleviate this problem, there are so-called “universal” remote controls on the market that can provide the functions of multiple remote controls in one device. Although universal remote controls are useful, they have drawbacks. Programming the remote can be a tedious process. Some controls are configured by entering a programming mode and then entering in a number of manufacturer-specific codes that will produce the correct commands for a given model. Some controls can learn commands. In a learning mode, the learning remote is placed up next to the original remote and keys from the original remote are actuated. The learning remote detects and records the codes resulting from this actuation, and the learning remote maps the codes onto one of its own buttons. In both of these scenarios, setting up a universal remote can be a complicated and tedious process that requires much reading of the user manual.

Another disadvantage to the universal remote is that the full functionality of the original remote can not always be fully realized on the universal remote. Some common commands are usually supported, such as volume, input selection, channels, etc. Others commands are specific to a particular manufacturer and model (e.g., “Go to my recorded programs” on a DVR, for example) and may not be included on a universal remote. Even if the user can have the universal remote learn an unsupported command, there may not be an appropriately labeled key on which to map the command, thus reducing the convenience of the remote for most people.

Finally, some specialized remote control features such as radio-frequency wireless transmission, variable stepping volume controls, etc., are rarely if ever implemented in a universal remote. Other features, even if implemented, may not work in the desired way. For example, some remotes utilize “macros,” which automatically perform a series of commands in sequence. However in many systems, commands like power-on and power-off are implemented as a toggle. A macro that relies on a power-toggle command to first turn a device on may not work under all conditions, because if a device is already turned on, the power toggle command will have opposite the desired effect, namely switching the device off.

The above-described difficulty in adapting generalized remote controls to work with particular equipment is just one category of problem that drives development of technologies like UPnP. In theory, if each of the above described home entertainment components was UPnP equipped, any function of these components could be operated remotely from a mobile computing device such as a cellular phone or PDA that also included UPnP capability. A UPnP controller could automatically discover available services of the controlled devices through using Simple Service Discovery Protocol (SSDP). Assuming such a UPnP controller had user configurable software, the controller could be easily and flexibly configured to use the UPnP home entertainment devices in the way that the manufacturers of the entertainment device intended. Other computing technologies such as Microsoft™ ActiveX™, Java™, may be used to allow controls from various manufactures to be combined into a single user interface, and thereby allow users to make custom control interfaces that are specially suited to their needs.

Although the present invention is described in relation to UPnP networks, it will be appreciated that the present invention may also be applicable to other technologies that allow digitally distributing computing tasks between devices coupled to a local area network. For example, the concepts described herein may be equally applicable to home automation networking technologies such as Zeroconf, Jini, HomeRF, IrDA, etc.

UPnP can be utilized by any type of network-capable appliance, machine, or device. As the standard developed, the use of UPnP for audio-video (AV) applications was seen as particularly useful. As such, a UPnP AV specification was established that defines UPnP device architectures for AV devices. This specification is referred to as UPnP AV. The UPnP AV specification is an adaptation of UPnP that allows consumer electronics devices to distribute entertainment content throughout a home network.

The UPnP AV specification defines a number of logical entities, including UPnP Media Server, UPnP Media Renderer, and UPnP Control Point. The Media Server has access to entertainment content, which may be located on a data store or a readable medium (e.g., disk drive, tape, or compact disc). The Media Server typically sends the entertainment content to one or more Media Renderers, which include hardware (e.g., displays, speakers) for rendering the content to a user. The Control Point coordinates the operation of the Media Server and Media Renderer to perform actions desired by the end-user. For example, the Control Point may query data available on the Media Server, allow a user to select content, and send a command that causes the Media Renderer to access and play the content.

Even though the UPnP is considered a peer-to-peer protocol, the operation of the UPnP Control Point relative to the UPnP Media Renderer and UPnP Media Server is somewhat like a traditional client-server architecture, in that the Control Point acts as a client (e.g., originating requests) and the Media Renderer/Server act as a server (e.g., waiting for requests to service). These logical devices may still be considered as “peer-to-peer” in the sense that the workload is distributed between a number of components. However, because the Control Point is a user interface device, it typically acts as a client, initiating network actions in response to user input. Unlike a traditional server, the Control Point, as defined in UPnP AV, usually does not act as a server, e.g., asynchronously servicing requests received from the network.

In the home networking realm, there may be benefit in providing devices that act as a server for “input device services.” These services could be used for specific applications, such as game controllers, or as general purpose input devices such as keyboards or pointing devices. Incorporating a “server” and “service” in an input device can benefit different home network devices that accept remote user inputs. Generally such an input device may be modeled as a UPnP logical device with eventing capability. A Control Point may locate an input device service using an UPnP M-Search. In response to locating the input device, the Control Point may subscribe to keyboard service itself. In another arrangement, the Control Point might assign the input device service to another UPnP device, such as a Media Server or Media Renderer. The UPnP device utilizing the input device service may register for events via the service. For example, a new event may be sent out for every key type event that originates from a keyboard device.

It will be appreciated that some UPnP devices, such as UPnP Control Points, accept user input, and may use the input to form an output. Such output may include some user-entered data, such as text entered by the user using a key pad. However, unlike an input device/service described herein, the Control Point does not send out this input data as generic “user input” events. Instead, the actions and outputs of a Control Point, for example, is defined in the various UPnP AV Device Control Protocols (DCP), which does not include a generic user input service. The events sent out via a UPnP user input service are preferably lowest common denominator, generic, outputs appropriate to the particular device (e.g., text, motion, and location). As such, these generic outputs can be used by a wide variety of devices simultaneously or serially without needing significant reconfiguration, negotiation, determination of state, etc., that may be typical of DCPs operating at a higher level of abstraction. In such a case, a device implementing the higher-level DCP may access and use the input service to facilitate the device's higher-level functions.

As described above, there may be some cases where a Control Point acts as an intermediary between an input device service and a controlled device that uses the service. The Control Point may set up a TCP connection (or arrange for other types of networking transactions, such as UDP/IP) between the input device and the controlled UPnP device. The Control Point may renew subscription to the controlled device, if necessary. The controlled device itself may also be able to renew subscription to the input device, e.g., by way of multicast events. The events originating from the input device may be any combination of unicast, multicast, or broadcast. Multicast events or broadcast events may have a tag telling to which device certain keyboard types are intended, thus facilitating multi-computer use. The Control Point may also be used to manage use of the input device when numerous controlled devices may be selected, e.g., telling the input device what is the user's desired target device.

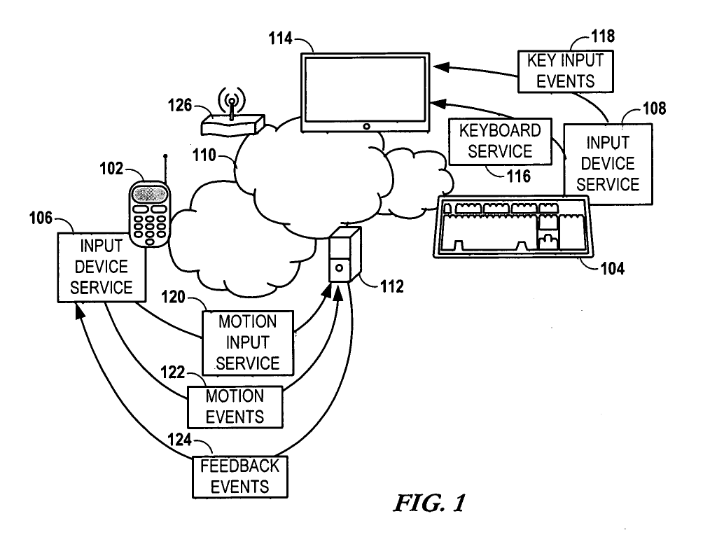

In reference now to FIG. 1, a block diagram illustrates a system according to an embodiment of the invention. In general, one or more mobile devices are equipped with processing and wireless local area networking (WLAN, or WiFi) capabilities. Here the mobile devices are shown as cell phone 102 and keyboard 104, but these concepts may be equally applicable to other devices such as portable digital assistant (PDA) mouse, pointer, portable media player, navigation unit, etc. The devices 102, 104 may support WiFi Protected Setup (WPS), which is a standard allowing for simplified connection of devices to a wireless network. The devices 102, 104 would also generally include a Transmission Control Protocol/Internet Protocol (TCP/IP) stack with Dynamic Host Configuration Protocol (DHCP) support for automatic address configuration. The devices 102, 104 (and their various features described hereinbelow) may also be compatible with other IP protocols, such as Universal Datagram Protocol over IP (UDP/IP), point-to-point tunneling protocol (PPTP) over IP, etc., or other non-IP networking protocols such as IPX, Appletalk, etc.

The devices 102, 104 may also include some sort of UPnP capability, such as by way of software additions and/or built in hardware features. For example, future versions of Intel's™ Centrino™ chipset may provide hardware support for UPnP, thereby easing the implementation in a device with minimal processing needs, such as keyboard 104. In the illustrated embodiment, devices 102, 104 implement UPnP input device services 106, 108 that are offered over an IP network 110. The mobile devices 102, 104 may include any combination of switches and sensors that allow detecting user inputs, including selection, variable adjustment (e.g., potentiometer), location, orientation, gestures, and movements, etc. A target device such as a game console 112 and/or television 114 can discover and use the services 106, 108. In this way, the mobile devices 102, 104 can be used to emulate an input device for any given target device.

In one example of operation, the keyboard 104 advertises the service 108 as “computer keyboard,” “text input device,” “keypad input device,” “cursor input device,” etc. The availability of any combination of these services may be broadcasted via SSDP service announcement and/or be provided in response to a service query (e.g., UPnP M-search message). Assuming a UPnP-capable device such as television 114 is interested in using the service 108, a service description 116 is received by the television 114 that allows the service 108 to be utilized. The service description 116 provides addresses and names of the services in the device 104. The television 114 may have an embedded UPnP Control Point (not shown) to receive the service description 116, and/or the service description may be received and utilized by an external Control Point. In this example, the keypad events may be sent using an event architecture adapted in the UPnP standard, such as the General Event Notification Architecture (GENA). In such a case, the television 114 subscribes to receive key input events 118 that are initiated by a user typing at the keyboard 104.

The interaction between the television 114 and service 108 allows the keyboard 104 to be adapted as a remote control for the television 114. The television 114 may use some of the key events 118 in the same way it would treat an infrared remote control event. For example, a numeric key, cursor key, volume control on a keyboard would respectively change channels, be used for navigation input, and change TV volume. Other keys could be mapped specially, such as mapping a computer keypad “Home” key to the TV menu. The television 114 could provide on-screen advice to indicate the mappings for other cases. For example, pressing the “F1” key could bring up the help menu, “Page Up” and “Page Down” could change input sources, etc. Where the keyboard 104 (or similar device) includes user output components (e.g., changeable key label displays, integrated keyboard-wide displays, touchscreen LCD/LED display) the establishment of the service between keyboard 104 and television 114 may involve the television 114 communicating the mappings to the keyboard 104. In such a case, the keyboard 104 can update the outputs and automatically reflect the current mapping. It should be noted that, even though the keyboard 104 may includes output hardware, the keyboard 104 is primarily designed to be a user input device. Therefore, any such user output components included with the keyboard 104 may be for limited purposes, such as communicating states to the user. Such a keyboard output device would therefore typically not need or include the functionality of a UPnP renderer, for example.

Another scenario is shown relative to the gaming console 112 and mobile device 102. The input device service 106 of the mobile device 102 may provide, via the network 110, a motion input service description 120. This description 120 may be provided in response to a service announcement and/or search request via UPnP service discovery. The motion events 122 may be any form of position, velocity, acceleration, etc., that provides an input to a video game. Other events (not shown), such as keypress events, may also be communicated suing similar or different communication channels. The event data may be sent out as a single message for a given event, and multiple simultaneous or near-simultaneous events may be grouped together into larger messages/packets to increase data transfer efficiency. Although other known devices used in the UPnP framework send out some events in response to user inputs (e.g., a Control Point sends a “browse” command to a Media Server in response to a user selection) these events are not at the level of “input events.” Instead, the user actions are abstracted to higher level UPnP functions such as “browse,” “select,” “play.” These high-level functions give no indication or description of the underlying user input device (e.g., key, switch) that originated the event.

In this example, the communicating devices 102, 122 may use an in-band UPnP mechanism or an out-of-band mechanism (non-UPnP) to provide the motion events 122 to the game console 112. The out-of-band mechanisms may be specially adapted for such outputs, and would generally need to be compatible with both devices 102, 112. The out-of-band data and protocols can be chosen to minimize latency and bandwidth, and/or to simply to use a more commonly available transmission mechanism. In one example of an out-of-band communication, the devices may form a direct, ad-hoc wireless local area network (WLAN) network connection to avoid latencies that may be seen if an infrastructure wireless access point 126 is used to relay the events 122. In another example, the out-of-band events may be relayed in a non-UPnP format, e.g., small, binary Universal Datagram Protocol packets that convey the motion event data 122.

The devices 106, 112 may also form an in-band or out-of-band reverse link, such as indicated by feedback events 124. The feedback events 124 may be used to activate a vibration element on the mobile device 102 to produce the effect of a force feedback game controller. Even in the case where the devices 106, 112 are communicating event data 122, 124 using out-of-band mechanisms, the UPnP service 106 may still be used for some control aspects related to the event data 122, 124 (e.g., terminating sessions, changing session parameters, etc.).

Although the illustration in FIG. 1 shows a single target device 112, 114 subscribing to each service 106, 108, it will be appreciated that multiple devices may subscribe to the services 106, 108 at the same time. For example, a home computer (not shown) could subscribe to the motion events 122 to record statistics such as calories burned simultaneously with the game play. Similarly, another device such as a DVR (not shown) may subscribe to the keyboard's key input events 118 at the same time that the television 114 is subscribed. This simultaneous reception of events can be efficiently implemented in a UPnP system by sending the event data via broadcast or multicast.

In typical computer use, devices such as a keyboard 104 are usually dedicated to a single device. Therefore, some adaptations may be needed if two or more target devices simultaneously receive the key input events 118. For example, in order to prevent confusion as to which target device the events are directed to, the keyboard 104 may have some arrangement (e.g., a function key) to select target devices, as well as means for determining current target device (e.g., LED indicators, LCD readout). In response to a target device being selected or deselected, inputs events may stop being sent to the unselected device. Alternatively, the events 118 may be sent with additional data (e.g., target identifier, bitmask) that informs respective target devices if the events are directed to them. This may be beneficial in some cases. For example, where the keyboard 104 has an integrated volume control, the user may always want volume change events to be sent to the television 114. However, all of the other events 118 should only be used by the target device if the keyboard 104 is in the correct mode.

In some situations, an input device 102, 104 may control multiple devices 112, 114 that may be located in different areas. For example, in a family room, mobile device 102 may control to be used to control game console 112, and in a bedroom the same device 102 is used to control the television 114. In both of these locations, the mobile device 102 data may communicated via the same wireless access point 126, therefore some sort of proximity detection between the controller 102 and target devices 112, 114 may be used to automatically engage and disengage the service for that device 112, 114. Such proximity detection may be enabled via UPnP over a proximity media access technology (e.g., short range, ad-hoc WLAN) or non-UPnP proximity detection via the same or different technology (e.g., RFID, Bluetooth, infrared).

In another aspect of the invention, a single target device may be able to utilize multiple input devices. For example, the user could control the game console 112 using the mobile device 102 and keyboard 104 at the same time. In this arrangement, some redundant, duplicative events (e.g., number key press) could originate from both sources devices 102, 104, whereas other events may be specific to the respective device, such as motion events from the mobile device 102 and special function key events from the keyboard 104.

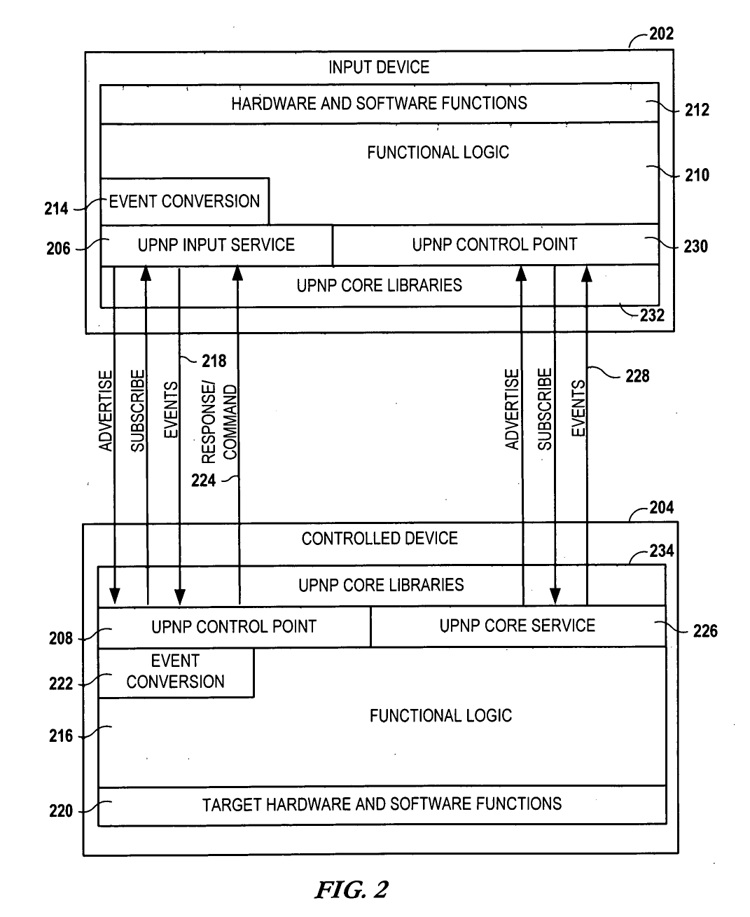

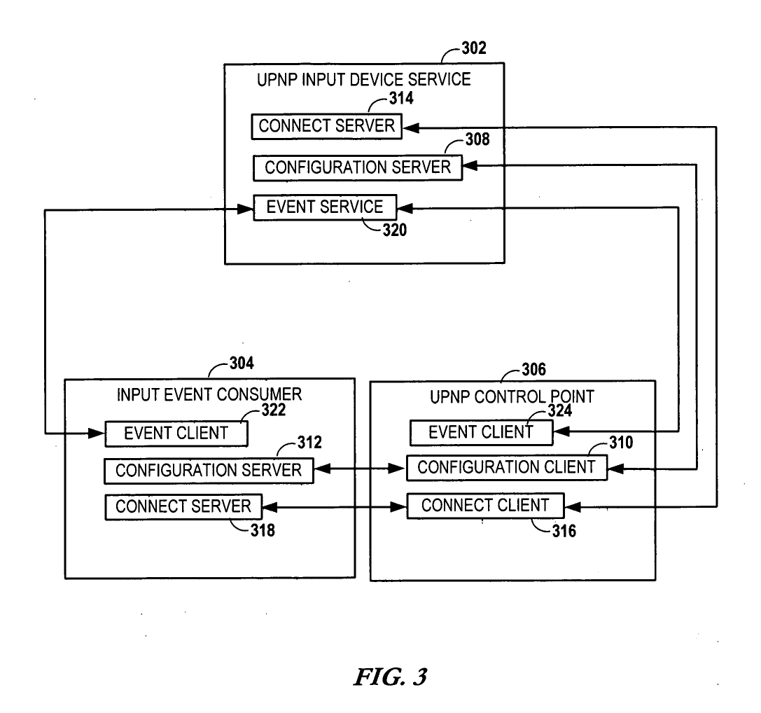

In reference now to FIG. 2, a block diagram illustrates various features that may be implemented in logical network devices according to embodiments of the invention. The illustrated implementation is based on terminology associated with the UPnP framework, although the concepts described herein may be applicable to analogous ad-hoc networking frameworks known in the art. The block diagram in FIG. 2 includes at least two physical devices, here represented as input device 202 and controlled device 204. The input device 202 at least provides a UPnP input service 206 that may be discovered and used like any other UPnP service. The controlled device 204 may include includes a controller function (here shown as a UPnP Control Point 208) that is capable of discovering and using input service 206. It will be appreciated that the Control Point 208 may be separate from the controlled device 204 (see, e.g., FIG. 3). In such a case, the controlled device 204 may include an alternate UPnP interface (not shown) that allows an external Control Point to direct the device 204 to connect to the input service 206.

The input service 206 of the input device 202 may include functional logic 210 that enables accessing states and data generated by low-level hardware/software functions 212 of the device 202. These states and data are translated into formats, states, timings, etc., needed by the UPnP service 206. The logic 210 may be part of the service 206, or may be some other application or system utility/API that accesses the hardware 212 directly and provides the data to all applications in an easy to use format. In the latter case, an event conversion module 214 may provide the data changes necessary for use by the UPnP input service 206. Otherwise, if the functional logic 210 is part of the UPnP service 206, then the logic 210 itself can perform the needed conversion.

Similar to the input device 202, the controlled device 204 will have internal functional logic 216 for dealing with input events 218 received from the input device 202. This logic 216 may be part of the UPnP Control Point 208 or be an application/utility/API for controlling target hardware and/or software 220. In the latter case, a conversion module 222 may be used to translate the UPnP event formats, timing, and states to a format needed by the target hardware/software 220. The target/hardware and software function 220 may be any function that can utilize device inputs 218, including, but not limited to, games, device configuration menus, device control, application user interfaces, etc.

In a minimal operational mode, the controlled device 204 may receive events from the service 206 of device 202 in a one-way event communication 218. These one-way communications 218 may be facilitated via unicast UPnP events that utilize reliable TCP/IP connections. This operational mode may also involve the sending of responsive events or commands 224 from the Control Point 208 to the service 206. For example, the response/command 224 may be an acknowledgement that a command was received, signal a change of state relevant to the sending to events 218, and other data related to the input service 206.

The input device 202 may also make use of states and data communicated from the controlled device 204 that are not necessarily related to the events of the input service 206. This type of data may originate from a unique function of the target device 204, here represented as UPnP core service 226. The events 228 communicated from this service 226 may be generally independent of the input service 206, although the events 218, 228 may have some relation as to the user experience. As seen in the diagram, the input device 202 may employ a control element such as UPnP Control Pont 230 to subscribe to this output service, although the Control Point 230 may be external to the input device 202.

As described above, data 224, 228 sent to the input device 202 may or may not be related to the input service 206. In one example, the input device 202 includes a motion sensor 212, and the input service 206 is a game/pointer service based on the motion sensor. The controlled device 204 in this scenario is a game console. A response/command 224 that could be related to the pointer events 218 would be a message from the Control Point 208 setting or changing the sensitivity of the motion sensor 212. One service 226 offered by the game console may be a motion output usable for activating a vibration device (e.g., force feedback). The input device 202 has a vibration inducer as part of its hardware 212, and the Control Point 230 takes the necessary actions to receive the feedback events 228 from the game service 226. Although there may be some relation in the game between the user's motion events 218 and the force feedback events 228, the force feedback events 228 may be sent independently of any motion events 218 (e.g., an alert, an impact that is not due to user movement, etc.).

It will be appreciated that any of the UPnP interface components 206, 208, 226, 230 may utilize common UPnP functions and libraries, as indicated by core libraries 232, 234. These libraries 232, 234 may perform functions common to all UPnP network components, such as network autoconfiguration, port assignment, XML parsing, etc. These common functions may already be included in a system, or may be added by way of a software update. Similarly the functions of the specific UPnP interface components 206, 208, 226, 230 can be added to devices that are capable of accepting software additions and upgrades. As described hereinabove, the capability to add/update software is being added to many types of devices that formerly relied on ROMs and firmware, including video games, mobile devices, media recorders, media players, etc.

In reference now to FIG. 3, a block diagram illustrates additional details of UPnP functional components according to embodiments of the invention. The functional components include a UPnP input device service 302 that may be included on a network capable input apparatus. An input event consumer 304 may be included in a device that receives user inputs, such as home entertainment electronics, video games, computers, etc. A UPnP Control Point 306 may be included in the same device as the input event consumer 304, or may be part of an independent and separate device.

The input device service 302 includes a configuration service 308 that enables a client to determine device capabilities and/or to set particular configurations of the service 302. For example, where the input device service 302 is for a keyboard, it is likely that there is no single kind of keyboard that will suit all users. There may be language/alphabet variations, extra buttons, sound controls, etc. Some of the properties set by way of the configuration server 308 here may be defined by UPnP forum in time, or left for vendors to decide. Typical configurations options for a keyboard input device might include: keyboard layout (e.g., 102 latin-1 type); mouse type (e.g., 2 or three buttons); assignments for special keys; out-of-band keyboard methods like telnet; multicast event activation; etc.

The Control Point 306 may include a configuration client 310 that allows the Control Point 306 to select various configuration options. These configuration selections may include automatic configurations and/or in response to user inputs. The configuration client 310 may also communicate with a configuration server 312 of the input event consumer 304. In one embodiment, the configuration client 310 can determine characteristics of input device service 302 and event consumer 304 via the respective configuration servers 308, 312, and automatically configure the entities 302, 304 for maximum compatibility.

The input device service 302 includes a connect service 314 that may be used by the Control Point 306 when pairing up the input device service 302 with an event consumer 304. A connect client 316 of the Control Point 316 may choose the best connection method based in data received from the connect server 314 of the input device service 302, as well as data that may be received from a connect server 318 of the event consumer 304.

The connect client 316 may determine and communicate the parameters used to connect an event service 320 of the input device service 302 to an event client 322 of the event consumer 304. The event server 320 generally sends out events of interest provided by the device service 302, such as key presses, location, sensor values, etc. The Control Point 306 may also directly subscribe to the event service 320 using its own event client 324. Although the term “event” may suggest discrete data packets or messages, it will be appreciated that the events provided by the event server 320 may include any combination of discrete message and continuous data streams. The events may be sent via one or more concurrent channels, or may use connectionless methods (e.g., UDP packets) to effect communications. The events may be sent from the event service 320 via any combination of unicast, multicast, and broadcast technologies. The event service 320 may be implemented as a standard UPnP eventing service and/or use multicast eventing (e.g., as defined in UPnP device architecture 1.1) to facilitate non-subscription based eventing.

A wireless networked UPnP input device such as a keyboard or game controller can conveniently be used to control any compatible home devices. It is convenient to set up, and can be used to access numerous disparate devices in a home network. Other features, such as proximity detection, can be used to select the appropriate device to control based on location. Such devices can be so enabled by additions to a UPnP stack and/or user applications, using technologies and software known in the art. In future implementations, UPnP functionality of such devices may become even more complex and include various state information like security credentials, Internet connectivity and remote access parameters, personal metadata and content collection, printer preferences etc. In such a case, it may be necessary to be able to transfer device and user specific content from one device to another. Typical examples of this device and user specific content relates to guest access, multiple device usage, and replacing old device with a new one.

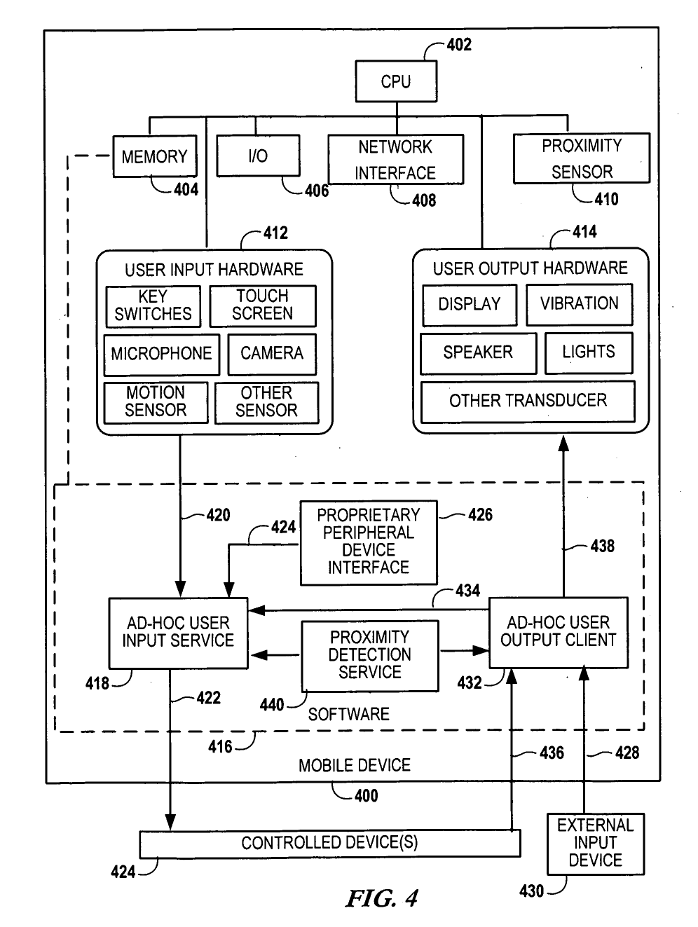

In reference now to FIG. 4, a block diagram illustrates a mobile device 400 that may host a network input device service according to embodiments of the invention. It will be appreciated that the mobile device 400 may be a general purpose mobile processing device, or special purpose processing device (e.g., embedded device). As is known in the art, such processing device 400 generally includes one or more central processing units (CPUs) 402. The CPU 402 may be coupled to any combination of memory 404, input/output bussing 406, network interfaces 408, and/or sensors, such as proximity sensor 410. The CPU 402 is further coupled to at least user input hardware 412, and optionally user output hardware 414.

The mobile device 400 may include multiple network interfaces 408 for maintaining any combination of wired or wireless data connections, and is capable of at least connecting to an IP network. A wireless network interface 408 may include wireless network circuitry such as a digital signal processor (DSP) employed to perform a variety of functions, including analog-to-digital (A/D) conversion, digital-to-analog (D/A) conversion, speech coding/decoding, encryption/decryption, error detection and correction, bit stream translation, filtering, etc. A transceiver (not shown) of the wireless network interface 408 transmits outgoing radio signals and receives the incoming radio signals associated with the device 400. The network interface 408 may be compatible any large scale voice and data communications infrastructure known in the art, including CDMA, W-CDMA, GSM, EDGE, etc. A local network interface 408 may also be capable of accessing via I/O and network technologies such as USB, Bluetooth, Ethernet, 802.11 Wi-Fi, IRDA, etc.

The memory 404 may include any combination of non-volatile electrically-erasable, programmable read-only memory (EEPROM), flash read-only memory (ROM), hard-drive, etc. so that the information is not lost upon power down of the mobile terminal 400. The memory 404 may also contain instruction in the form of software 416 for carrying out conventional operations in accordance with the present invention. The software 416 may be entered into the device 400 by way of computer-readable medium, and may also be transmitted to the mobile device 400 via data signals, such as being electronically downloaded via the network interface 408 from more networks, such as the Internet and an intermediate wireless network(s).

The software 416 may include an ad hoc user input service 418 that receives events 420 from internal input hardware 412 and sends these as network events 422 to a controlled device 424 via an IP network using an ad-hoc peer-to-peer protocol of the IP network. The device 400 may also be able to receive events 424 from a peripheral device (not shown) by way of a proprietary peripheral device interface 426. The events 424 may also be sent as events 422 to the controlled device 424 instead of or in combination with the internal events 420. For example, the device 400 may be a mobile wireless keyboard, and a mouse may connect to the interface 426 (e.g., via PS-2 port, USB port, Bluetooth connection). The output events 422 in this example may include both the internally generated keypress events 420 and externally generated mouse movement events 424.

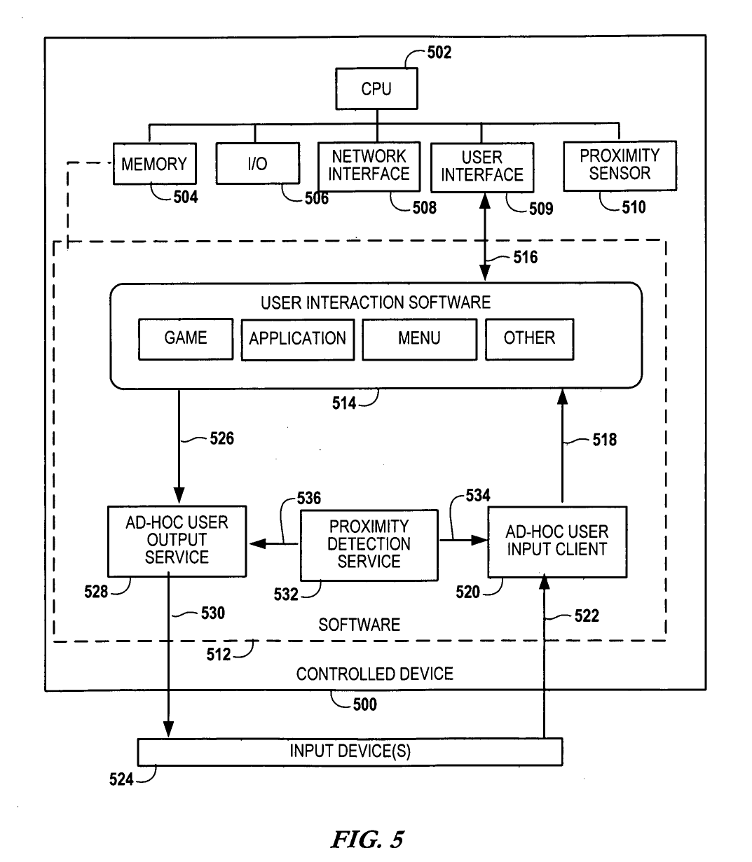

In the same way that the user input service 418 provides events from a peripheral interface 426, the input service 418 may also receive and forward events 428 from a similar networked input device 430. The mobile device 200 may include an ad-hoc user output client 432 (or ad-hoc user input client 520 as shown in FIG. 5) for receiving these events 428, and forwarding 434 this data to the user input service 418. In the keyboard example described above, the external input device 430 may be a mouse capable of communicating via the ad-hoc peer-to-peer IP network. Instead of having the controlled device 424 connect to the devices 400, 430 separately, the device 400 can receive and consolidate events from both devices 400, 430 and send the consolidated events 422 to the controlled device 424.

The ad-hoc user output client 416 may also use the received input events 428 to cause a change in the user output hardware 414, generally by way of a user application (not shown). The user output client 432 may also receive feedback events 436 from the controlled device 424. The client 432 may use the feedback events 436 to send data 438 to the output hardware 414. This data 438 may be used for such purpose as indicating system states, feedback responses related to input events 422, or causing changes to user input hardware 414 that are entirely unrelated to the input events 422.

An additional feature that may be included in the software 416 is represented by the proximity detection service 440. This service 440 may detect proximity to relevant network entities (e.g., devices 424, 430) such as via proximity sensor 410. The proximity detection service 440 may automatically adjust the operation of the various ad-hoc components 418, 432 in response to these sensor readings. For example, the proximity detection service 440 may cause the user input service 418 to stop in response to determining that the current controlled device 424 is no longer proximate. The distance for which such proximity actions may be triggered may depend on both the proximity technology used, as well as the nature of the interactions between the mobile device 400 and controlled device 424. The proximity detection service 440 and/or sensor 410 may also be used for such purposes as WiFi Protected Setup.

In reference now to FIG. 5, a block diagram illustrates a controlled device 500 according to embodiments of the invention. The controlled device may include a CPU 502, memory 504, I/O 506, network interface 507, user interface 508, and proximity sensor 510 having characteristics similar to like-named components that were shown and described relative to FIG. 4. The memory 504 includes instructions/software 512 that may include user interaction software 514. The user interaction software 514 may be capable sending outputs 516 to user interface hardware 508 in response to inputs 518 received from an ad-hoc user input client 520. The user input client 520 forms the inputs 518 based on events 522 received from one or more networked input devices 524. The user interaction software 514 may also send outputs 526 that are sent to an ad-hoc user output service 528. The user output service 528 sends the outputs 526 as network events 530 targeted to one or more input devices 524.

The output events 526 may be based on events 518 received from the input device 524, such as game play events. The output events 526 may also be based on events received via the local user interface 508. For example, the user may actuate a knob or switch of the user interface 508 which is sent as a configuration event to the input device 524. This may be used, for example, make fine changes to sensitivity of a motion sensing cell phone 524 by adjusting an easily reachable control 508 of the controlled device 500 instead of having to open and make changes using a less convenient interface of the phone 524. As with the mobile device 400 of FIG. 4, the controlled device 500 may be able to modify behavior of the ad-hoc network components 520, 528 via a proximity detection service 532. The proximity service 532 may detect proximity of the input device 524 via proximity sensor 510, and communicate this to the ad-hoc network components 520, 528 via events 534, 536.

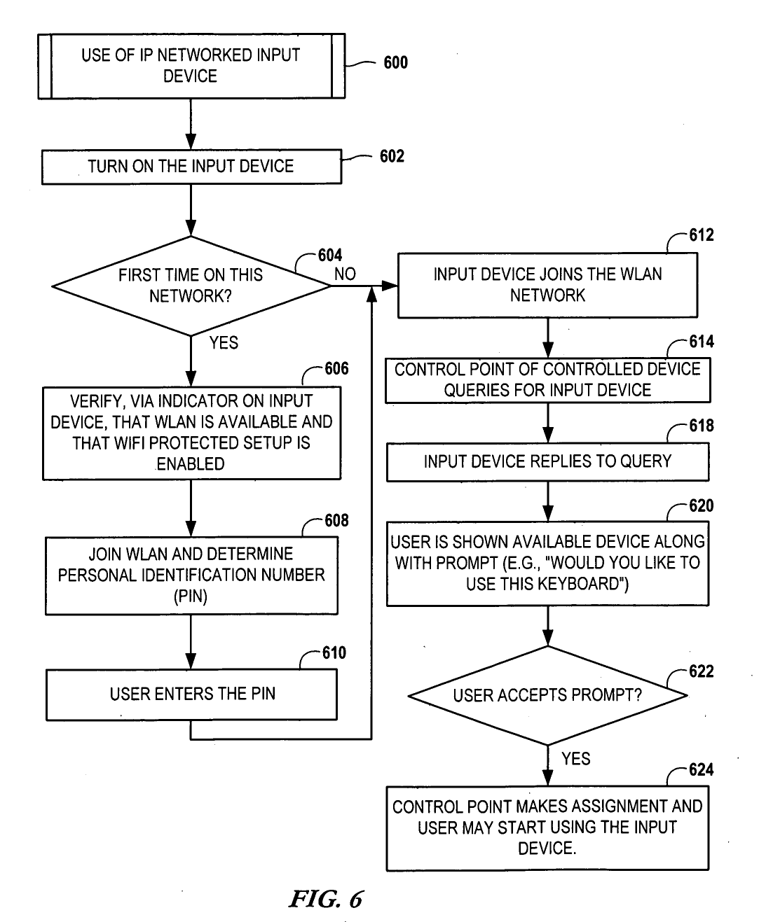

In reference now to FIG. 6, a flowchart illustrates an example use procedure 600 of an input device according to an embodiment of the invention. The first step is to turn on 602 the input device, which may include waking the device up from a sleep state. The device determines 604 that it is the first time it has connected to the current network (e.g., by way of the SSID) then the user may verify 606 that the WLAN is detected and available, and (optionally) that WiFi Protected Setup is enabled. This verification 606 may be enabled via an LED indicator or small display on the input device, or by other means (e.g., plugging the device into a USB port of a computer for initial setup). The user may press a button (or use some other control) to join 608 the WLAN, and the user is provided the personal identification number (PIN). The PIN may be provided by a display on the device, via a label on the device, etc. The user enters 610 the PIN at the WLAN access point (AP) and the device can thereafter join 612 the home WLAN network. It will be appreciated that alternate WiFi Protected Setup initialization modes can be used instead of user entry of a PIN. Those alternate modes include simultaneously pushing a button on both the AP and input device, using near field communications to transmit PIN data, and/or transferring of PIN data between the AP and input device using a portable USB memory device.

After the network has been joined 612, a Control Point (e.g., remote controller, phone, target device) queries 614 for the input device, and the input device replies 618. The user is shown the available device, and may be prompted (e.g., “Would you like to use this keyboard with this server?”). If the user accepts 622, then the Control Point makes the assignment (e.g., sets up connection parameters) and user may thereafter start using 624 the input device. It will be appreciated that actions 614, 618, 620, and 622 may also be needed only for an initial setup, and thereafter the user may use 624 the input device immediately following the device's joining 612 of the network.

As described above, a network capable input device may be used to provide primary or alternate user inputs to a home electronics device such as a DVR, television, game console, smart appliance, etc. The concepts of the invention may also be applied to control small devices with limited (or no) user interface features, such as a handheld terminal. Such an adaptation may also enable new applications, like virtual Post-It™ notes and chat in the home domain.

As described, an input device may offer any type of user input as a UPnP service via a home network. Another more specific implementation, that may be particularly suited to text input devices, is to define an API that extends and enables written communication in home domain regardless of the originating device. The success of SMS, chat and email via the wide area networks such as the Internet suggests that such applications may be expanded and refined to better suit home network uses. As such, new applications and use cases such as home domain electrical Post-It notes can take advantage of network-capable input devices as described above, and enable writing documents, emails and SMS with a properly configured input device.

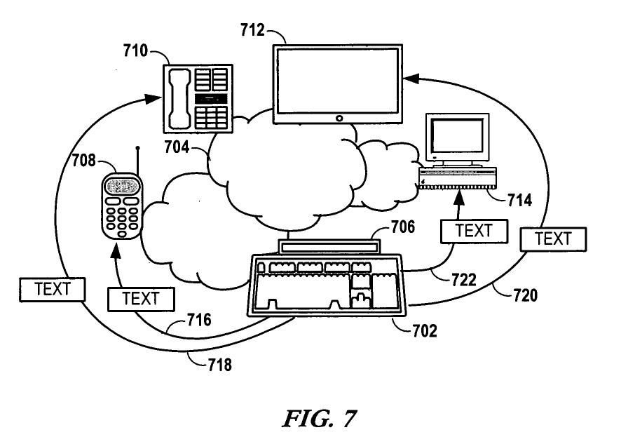

In reference now to FIG. 7, a block diagram illustrates a home domain text messaging system according to an embodiment of the invention. Generally, at least one network-capable text input device (here shown as keyboard 702) includes a text messaging service suited to an ad-hoc, peer-to-peer home IP network 704, such as a UPnP network. The keyboard 702 may be configured as a standalone device for providing the text messaging service, and as such may include a small display 706 that allows users to compose simple text messages. The keyboard 702 may also be part of another device (e.g., laptop computer) that provides the service.

A number of other user devices are also coupled to the IP network 704. Example user devices shown in FIG. 7 include mobile phone 708, packet switched telephone circuit (PSTN) phone 710, television/DVR 712, and personal computer (PC) 714. These devices 708, 710, 712, 714 may include a client that is capable of receiving messages from the text service of the keyboard 702. The keyboard 702 may include a special key (e.g., send electronic note) that causes the keyboard to enter a special entry mode. The user types in a message on the keyboard 702, and there may be special keys that allow the user to review and modify the message via the minimal display 706. After the message is complete, the user presses a “send” key on the keyboard 702. In an alternate implementation, the characters may be streamed as they are being typed, and thus there is no need for the user to use a “send” command.

In response to the message creation, the keyboard sends/streams text messages 716, 718, 720, and 722 to respective devices 708, 710, 712, 714. These messages 716, 718, 720, 722 may be sent via separate channels of communication, or may be broadcast/multicast over the network 704. Each receiving device 708, 710, 712, 714 may handle the respective messages 716, 718, 720, 722 differently depending on internal configuration of the client and/or data included with the messages 716, 718, 720, 722. For example, the mobile device 708 may send message 716 to a text messaging and/or notes application of the device 708. The telephone 710 may perform voice synthesis to turn message 718 into a voice mail. In this way, the user may be able to compose a message as a reminder to himself/herself or somebody else. Sending the message to all capable home devices ensures the message is received on the first device in the home with which the recipient later interacts.

The system described in FIG. 7 may have additional features that prevent too many messages from proliferating on the system. For example, the composer of the message may just want the message received once, and all other instances of the messages stored on other devices 708, 710, 712, 714 may be de-emphasized or deleted. As such, the receiving device where the message is read/heard may send a message (not shown) back to the keyboard 702 saying the message has been read. The keyboard may then send a cancellation message (e.g., referring to a unique identifier attached to the original messages 716, 718, 720, 722) so that the other devices do not show the message to the user again. The other devices may just flag the messages 716, 718, 720, 722 as read/heard, or delete them completely.

A text messaging system such as shown in FIG. 7 may also include adaptations that minimize network traffic when sending data to multiple targets 708, 710, 712, 714. If keyboard event is sent by UPnP event, then it may be known by both network endpoints. that an event was received. If a Telnet-like protocol is used, then a Nagle algorithm or the like can be applied to conglomerate individual pieces of data (e.g., characters) to reduce the number of individual packets/messages be transmitted on the network. For example, it may be possible to configure a UPnP application events to buffer characters as they are being input, and send all buffered characters within a specified time interval, e.g., one second.

It will be appreciated that the above description may be applicable to real-time text messaging applications such as chat. Instead of the user inputting text in the keyboard 702 for later use, the user may be trying to communicate with somebody else in the house. As such, each targeted device 708, 710, 712, 714 may show an alert and the message text 716, 718, 720, 722 as it is being input. Similar to the above description, if the recipient sends a reply using one of the devices 708, 710, 712, 714, then the keyboard 702 may signal to the unused devices to disengage from the text session (or the unused devices disengage on their own). It will be appreciated that the system may also be configured for direct, point-to-point text messaging between the keyboard and one or more of the target devices 708, 710, 712, 714, similar to Internet instant messaging.

A UPnP keyboard device 702 and recipient devices 708, 710, 712, 714 may require a standard API on top of the peer-to-peer network protocols in order to utilize the home messaging services. For example, the text input device (e.g., keyboard 702) may implement a UPnP action call SubmitCharacters(string, destination, <optional SessionId>). The text input device 702 can submit n-number of characters in the “string” parameter by using this single UPnP action call. The “destination” parameter may be capable of defining the target application on the receiving device. For example, the destination may specify applications such as: 1. Not specified (e.g., clipboard); 2. SMS Application; 3. Notes; 4. Email; 5. Text-to-Voice.

In this scenario, one or more characters can be posted to the text input device by using SubmitCharacters action. The user of the action can control which application should receive the text flow. A sessionID parameter can be used to distinguish text flows of different Control Points (see below). SubmitCharacters returns the number of posted characters to its caller, and if no sessionID is defined, the total number of posted characters to the defined application.

The input device 702 may also be able to send network events that contain data analogous to that contained in the SubmitCharacters action call (e.g., string, destination, session ID). In such a case, when a user presses a key switch, characters resulting from the key events are sent to a target device as an UPnP event. In another variation, a Control Point may use the SubmitCharacters action of text input device. The text input device could echo the text content to the whole UPnP network by using multicast eventing mechanism. The text flow in such an example may be sent from the Control Point to the text input device as unicast, and the text input device would forward the text flow further as multicast messages.

Other UPnP action calls that may be implemented in this API include GetTextInputApplications( ), which returns list of applications for supporting text input. The list of applications may include a listing of currently subscribed applications. In another configuration, the listing may include a type of application that is defined by generic description of the type and format of text data that is sent by the input device (e.g., streaming real-time text, message text, controller-text, etc.). Other UPnP action calls that may be implemented in an input device API include CreateAssociation(application), which allows a Control Point to create an association of text input to desired application group, and EraseCharacter(number of characters, application), which may be used to erase characters (e.g., in a text streaming mode) or an entire message. In one example, a Control Point can erase a number of submitted characters using EraseCharacter. If the Control Point is only erasing its own text, a sessionID may need to be defined. Generally, any operation of the API can be bound to specific sessions by providing a session ID. The session ID can be created by using an action such as CreateInputSession( ). The API may utilize a 12-character sessionID that guarantees submitting and erasing operations can be done by a specific Control Point.

It will be appreciated that such an API may need to deal with issues relating to direct real-time text input, such as may be seen with a chat application. Where a real-time text input application uses TCP for transport, the network layer ensures that packets are not lost and correctly ordered. However, other protocols such as UDP/IP are not designed to provide reliable delivery. In the latter case, real time user inputs to a device (e.g., UPnP erasing using the EraseCharacter action) may not work. To resolve this issue, the real-time text input applications could use an API action such as QueryInput (Session, index) to verify received data and/or recover lost data. A keyboard (or similar input device) may have random access memory capable of storing key events in a buffer. With QueryInput, it would be possible to get a part or full transcript of a messaging session from the buffer, such as in the form of an XML formatted file, with sequence ID of each individual message in a session. It may also be possible to determine the eventing index of the last modified input session and/or SOAP action by way of QueryInput.

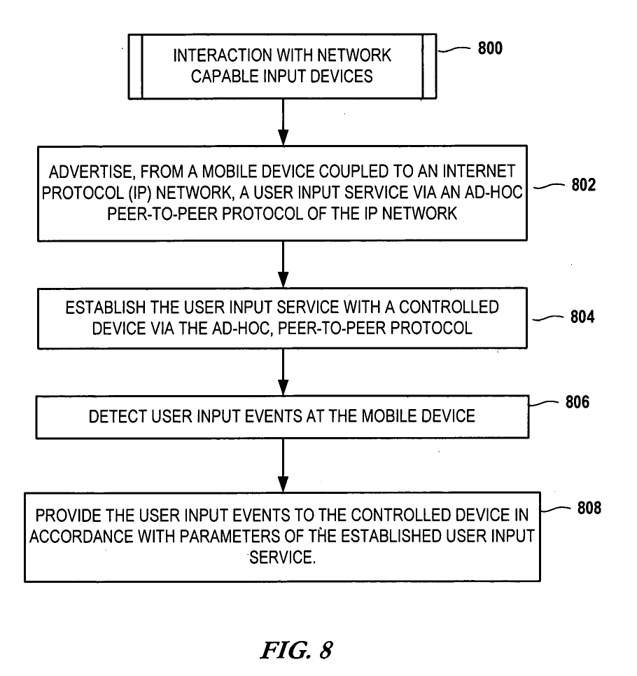

In reference now to FIG. 8, a flowchart illustrates a procedure 800 for interacting with network capable input devices according to an embodiment of the invention. The procedure 800 involves advertising 802, from a mobile device coupled to an Internet Protocol (IP) network, a user input service via an ad-hoc peer-to-peer protocol of the IP network. The user input service is established 704 with a controlled device via the ad-hoc, peer-to-peer protocol. User input events are detected 706 at the mobile device, and the user input events are provided 708 to the controlled device in accordance with parameters of the established user input service.

As will be apparent from reading the above disclosure, embodiments of the invention may be implemented using data processing devices. The functionality of these devices may be realized through the use of instructions that are stored to memory and executed on one or more central processing units. These instructions may be stored and distributed in any form known in the art, including computer readable medium such as magnetic or optical media. The instructions may also be transmitted to the target devices via wired or wireless networks.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A mobile apparatus comprising:
a user input device;
at least one network interface capable of being coupled to an Internet Protocol (IP) network;
a processor coupled to the network interface and the user input device; and
memory coupled to the processor, wherein the memory includes instructions that cause the processor to:
advertise a user input service via an ad-hoc, peer-to-peer protocol of the IP network;
establish the user input service with a controlled device via the ad-hoc, peer-to-peer protocol;
detect user input events from the user input device; and
provide the user input events to the controlled device in accordance with parameters of the established user input service.

2. The apparatus of claim 1, wherein the instructions cause the processor to provide the user input events to the controlled device via the IP network.

3. The apparatus of claim 2, wherein the instructions cause the processor to provide the user input events to the controlled device via the ad-hoc, peer-to-peer protocol of the IP network.

4. The apparatus of claim 1, wherein the instructions cause the processor to provide the user input events to the controlled device via a direct wireless ad-hoc connection coupling the mobile apparatus to the controlled device.

5. The apparatus of claim 1, wherein the user input device comprises a motion sensor, and wherein the user input events comprise motion events.

6. The apparatus of claim 1, wherein the user input device comprises key switches, and wherein the user input events comprise key press events.

7. The apparatus of claim 1, wherein the instructions further cause the processor to:
discover a user output service of the controlled device via the ad-hoc, peer-to-peer protocol;
establish the user output service with the controlled device via the ad-hoc, peer-to-peer protocol;
receive user output events from the user output service; and
translate the user output events to user-perceivable signals via the user output device, wherein the user output signals are related to an activity being engaged in by the user on the controlled device using the user input signals.

8. The apparatus of claim 1, wherein the user input service comprises a text messaging service, and wherein the controlled device comprises a text messaging receiving device capable of enabling rendering text data to the user from the text messaging service.

9. The apparatus of claim 8, wherein the text data includes a destination entry describing a target application of the text messaging receiving device for processing the text data.

10. The apparatus of claim 8, wherein the controlled device comprises a plurality of text messaging devices capable of simultaneously receiving the text data.

11. A method comprising:
advertising, from a mobile device coupled to an Internet Protocol (IP) network, a user input service via an ad-hoc peer-to-peer protocol of the IP network;
establishing the user input service with a controlled device via the ad-hoc, peer-to-peer protocol;
detecting user input events at the mobile device; and
providing the user input events to the controlled device in accordance with parameters of the established user input service.

12. The method of claim 11, wherein providing the user input events to the controlled device comprises providing the user input events to the controlled device via the IP network.

13. The method of claim 12, wherein providing the user input events to the controlled device via the IP network comprises providing the user input events to the controlled device via the ad-hoc, peer-to-peer protocol of the IP network.

14. The method of claim 11, wherein providing the user input events to the controlled device comprises providing the user input events to the controlled device via a direct wireless ad-hoc connection coupling the mobile apparatus to the controlled device.

15. The method of claim 11, wherein the user input device comprises a motion sensor, and wherein the user input events comprise motion events.

16. The method of claim 11, the further comprising:
discovering a user output service of the controlled device via the ad-hoc, peer-to-peer protocol;
establishing the user output service with the controlled device via the ad-hoc, peer-to-peer protocol;
receiving user output events from the user output service; and
translating the user output events to user-perceivable signals via the user output device, wherein the user output signals are related to an activity being engaged in by the user on the controlled device using the user input signals.

17. The method of claim 1, wherein the user input service comprises a text messaging service, and wherein the controlled device comprises a text messaging receiving device capable of enabling rendering text data to the user from the text messaging service.

18. A computer-readable storage medium including instructions executable by a processor of a mobile device for:
advertise a user input service via an ad-hoc, peer-to-peer protocol of an IP network;
establish the user input service with a controlled device via the ad-hoc, peer-to-peer protocol;
detect user input events from user input hardware of the mobile apparatus; and
provide the user input events to the controlled device in accordance with parameters of the established user input service.

19. An apparatus comprising:
at least one network interface capable of being coupled to an Internet Protocol (IP) network;
a processor coupled to the network interface; and
memory coupled to the processor, wherein the memory includes a user application and instructions that causes the processor to:
discover a user input service via an ad-hoc, peer-to-peer protocol of the IP network;
establish the user input service via the ad-hoc, peer-to-peer protocol for providing user inputs to the user application;
receive user input events from the user input service in accordance with parameters of the established user input service; and
provide the user input events to the user application.

20. The apparatus of claim 19, wherein the instructions further cause the processor to:
advertise a user output service of the apparatus via the ad-hoc, peer-to-peer protocol;
establish the user output service with an input device that provides the user input service via the ad-hoc, peer-to-peer protocol; and
send user output events to the user input device, wherein the user input device translates the user output events to user-perceivable signals, wherein the user output signals are related to an activity being engaged in by the user on the controlled device using the user input signals.

21. A system comprising:
a mobile apparatus and controlled device capable of being coupled to an Internet protocol (IP) network that utilizes an ad-hoc peer-to-peer protocol, wherein the mobile apparatus comprises:
means for advertising a user input service via the ad-hoc, peer-to-peer protocol of the IP network;
means for establishing the user input service with a controlled device via the ad-hoc, peer-to-peer protocol;
means for detecting user input events at the mobile apparatus; and
means for providing the user input events to the controlled device in
accordance with parameters of the established user input service; and and wherein the controlled device comprises:
a user application;
means for discovering the user input service via the ad-hoc, peer-to-peer protocol of the IP network;
means for establishing the user input service via the ad-hoc, peer-to-peer protocol for providing user inputs to the user application;
means for receiving user input events from the user input service in accordance with parameters of the established user input service; and
means for providing the user input events to the user application.
